(19) United States
(12) Patent Application Publication
(10) Pub. No.: US 2021/0243973 A1
(43) Pub. Date: Aug. 12, 2021

(54) VEGETATION DISPLAY STAND

(71) Applicant: Edible Garden Corp., Belvidere, NJ (US)

(72) Inventors: James E. Kras, Highlands, NJ (US); Kelly M. Jimenez, Jersey City, NJ (US)

(21) Appl. No.: 17/170,063

(22) Filed: Feb. 8, 2021

Related U.S. Application Data
(60) Provisional application No. 62/972,258, filed on Feb. 10, 2020.

(51) Int. Cl. A01G 27/00; A01G 9/02; A47F 7/00

(52) U.S. Cl. CPC A01G 27/003; A47F 7/0078; A01G 9/023; A01G 27/005

(57) ABSTRACT

Disclosed are embodiments of an apparatus for displaying and watering vegetation, which watering can be automated. The apparatus can include a base portion, a support member coupled with the base portion and extending generally upwardly away from the base portion, a bracket, a tray supported by the bracket, a container, at least one conduit in fluid communication with the container and configured to communicate a liquid from the container to the tray, and a pump comprising electronic circuitry configured to control an operation of the pump. The pump can be configured to pump a liquid from the container through the conduit to the tray to water at least one plant that can be supported by the tray.

### INCORPORATION BY REFERENCE TO ANY PRIORITY APPLICATIONS

The present application claims priority from U.S. Patent Application No. 62/972,258, filed on Feb. 10, 2020, titled VEGETATION DISPLAY STAND, the contents of which priority application is hereby incorporated by reference herein in its entirety as if fully set forth herein. The benefit of priority is claimed under the appropriate legal basis including, without limitation, under 35 U.S.C. § 119(e). Any and all applications for which a foreign or domestic priority claim is identified in the Application Data Sheet as filed with the present application are hereby incorporated by reference herein in their entirety and made a part of this specification.

### BACKGROUND OF THE DISCLOSURE

### Field of the Disclosure

This disclosure relates to automated apparatuses for watering and displaying vegetation.

### Description of the Related Art

Plant displays are typically stationary and fixed, making them infeasible to move around a store, warehouse, or other location. A need exists for a self-contained, mobile display stand for vegetation.

### SUMMARY OF SOME EXEMPLIFYING EMBODIMENTS

An embodiment of an apparatus for displaying and automatically watering vegetation, that can have a base portion, a support member coupled with the base portion and a bracket, a tray supported by the bracket, a container, at least one conduit in fluid communication with the container and configured to communicate a liquid from the container to the tray, and a pump that can have electronic circuitry configured to control an operation of the pump. In any embodiments, the apparatus the support member can extend generally upwardly away from the base portion. Further, the pump can be configured to pump a liquid from the container through the conduit to the tray to water at least one plant that can be supported by the tray.

### Container Details

In any embodiments of the apparatuses of any of the preceding paragraphs, the container can be removable from the base portion, the container can be configured such that a level of a liquid within the container can be seen without opening the container, and/or the container can be positioned within an enclosure of the base portion.

### Tray Details

In any embodiments of the apparatuses of any of the preceding paragraphs, in any combination: the tray can have at least one channel extending in at least a first direction across the tray to provide the liquid to one or more plants supported by the tray; the tray can have a plurality of channels extending in a first direction and a second direction across the tray to provide the liquid to one or more plants supported by the tray, the second direction being approximately perpendicular to the first direction; the channel can have a plurality of spaced apart depressions; the channel can have a plurality depressions, wherein each of the depressions can be sized and configured to receive a potted plant; the apparatus can have two trays, or four trays, or more than four trays; the apparatus can have one or more racks supported by the support member; each of the one or more racks can be configured to support a plant; the tray can be removably supported by at least one bracket; the tray being removable from the at least one bracket without the use of tools; the tray can be removably supported by the bracket, the tray being removable from the bracket by only moving the tray away from the bracket; the apparatus further has a plurality of brackets and a plurality of trays; the apparatus further can further have a plurality of brackets supporting a plurality of trays; the bracket can have a first bracket portion and a second bracket portion, the first bracket portion extends in a first direction, and the second bracket portion extends in a second direction and supports a second tray, the second direction being opposite to the first direction; the bracket can have a first bracket portion extending in a first direction and a second bracket portion extending in a second direction, the second direction being opposite to the first direction, and the apparatus can have a tray supported on each of the first bracket portion and the second bracket portion; and/or the apparatus can have a plurality of brackets, wherein each of the plurality of brackets can be configured to support at least one tray; and/or the apparatus can have a plurality of brackets, wherein each of the plurality of brackets can be configured to support at least two trays.

### Base Portion

In any embodiments of the apparatuses of any of the preceding paragraphs: the base portion can have a cabinet; the base portion can have a plurality of wheels configured to support the apparatus and permit the apparatus to be rolled; the base portion can have a cabinet having a door; and/or the base portion can have a viewing window in a portion of the base portion, wherein the viewing window can be aligned with the container to permit a viewing of a level of a liquid within the container.

### Pump and Electronics

In any embodiments of the apparatuses of any of the preceding paragraphs: the pump can have electronics that can have a processor and a machine-readable memory; the electronic circuitry of the pump can have a machine-readable memory storing executable instructions, the electronic circuitry being configured to activate the pump to provide a predetermined amount of the liquid from the container to the tray at a predetermined frequency, based on an actuation from a timer in communication with the other components of the electronics, based on an actuation of a button, switch, dial, or other input device, or otherwise, and/or upon the occurrence of a predetermined event when the apparatus is in an operable state; the predetermined event can include a level of the liquid in the tray reaching a predetermined value; the predetermined event can include a level of the liquid in the tray reaching an approximately zero value; the predetermined event can occur when the tray becomes substantially dry; the predetermined event can occur when a moisture level within one or more plants supported by the tray reaches a predetermined level; the apparatus can have a source of power in communication with at least the pump; the apparatus can have one or more batteries, an AC power source, a DC power source, and/or a solar panel; and/or the apparatus can further have a wireless communications device electronically coupled with the electronic circuitry.

### Sensors

In any embodiments of the apparatuses of any of the preceding paragraphs: the apparatus can have one or more sensors configured to determine a level of a liquid within the tray; the apparatus can have at least one sensor for each tray of the apparatus; and/or the liquid can be water.

An apparatus for displaying and automatically watering vegetation, that can have a base portion, a frame coupled with the base portion, one or more trays supported by the frame, each of the one or more trays that can have at least one channel, a refillable liquid container, at least one conduit in fluid communication with the container and configured to communicate a liquid from the container to one or more plants supported by the one or more trays, and a pump that can have electronic circuitry configured to control an operation of the pump. In any embodiments, during operation of the apparatus, the pump can be configured to automatically pump a liquid from the container through the conduit to the at least one channel of each of the one or more trays at a predetermined frequency or when a liquid level within the at least one channel of at least one of the one or more trays reaches a predetermined level.

### BRIEF DESCRIPTION OF THE DRAWINGS

Other features and advantages of the present disclosure will be apparent from the following detailed description, taken in conjunction with the accompanying drawings of which:

FIG. 1 is a top, front, and left side perspective view of an embodiment of a vegetation display apparatus.

FIG. 2 is a bottom, rear, and right side perspective view of the embodiment of the apparatus of FIG. 1.

FIG. 3 is a top, front, and left side perspective view of the embodiment of the apparatus of FIG. 1, with a door of the cabinet in an open position.

FIG. 4 is a front view of the embodiment of the apparatus of FIG. 1.

FIG. 5 is a rear view of the embodiment of the apparatus of FIG. 1.

FIG. 6 is a side view of the embodiment of the apparatus of FIG. 1.

FIG. 7 is a top view of the embodiment of the apparatus of FIG. 1.

FIG. 8 is a schematic illustration of an embodiment of the apparatus or a portion thereof.

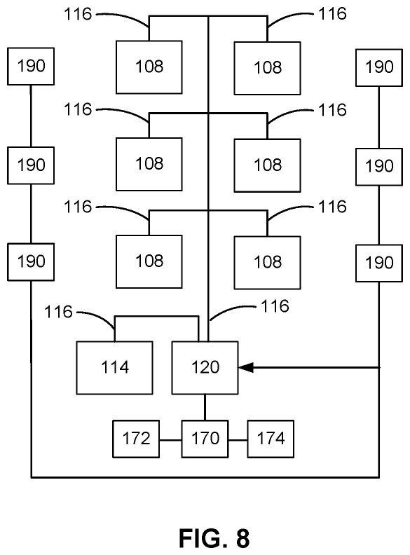

### DETAILED DESCRIPTION OF THE SOME EXEMPLIFYING EMBODIMENTS

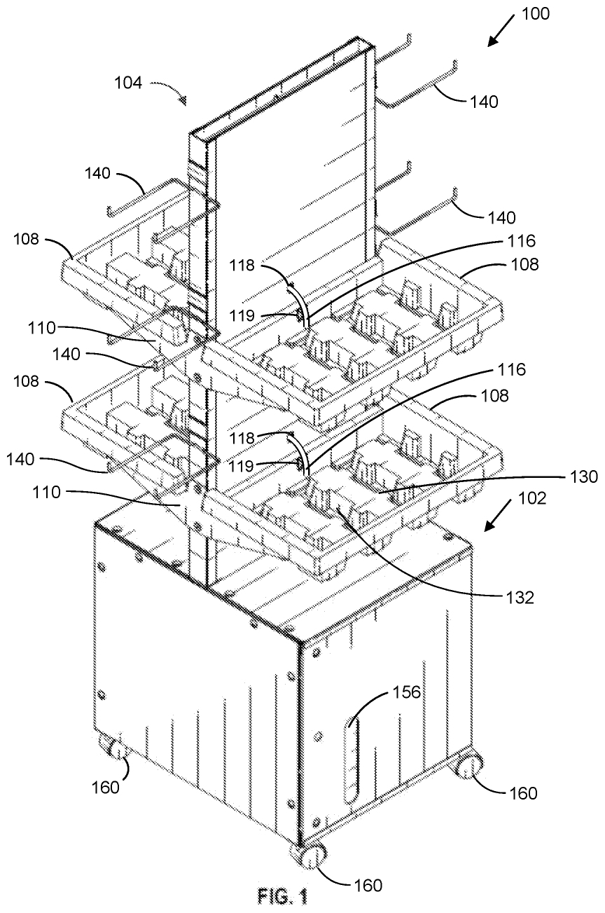

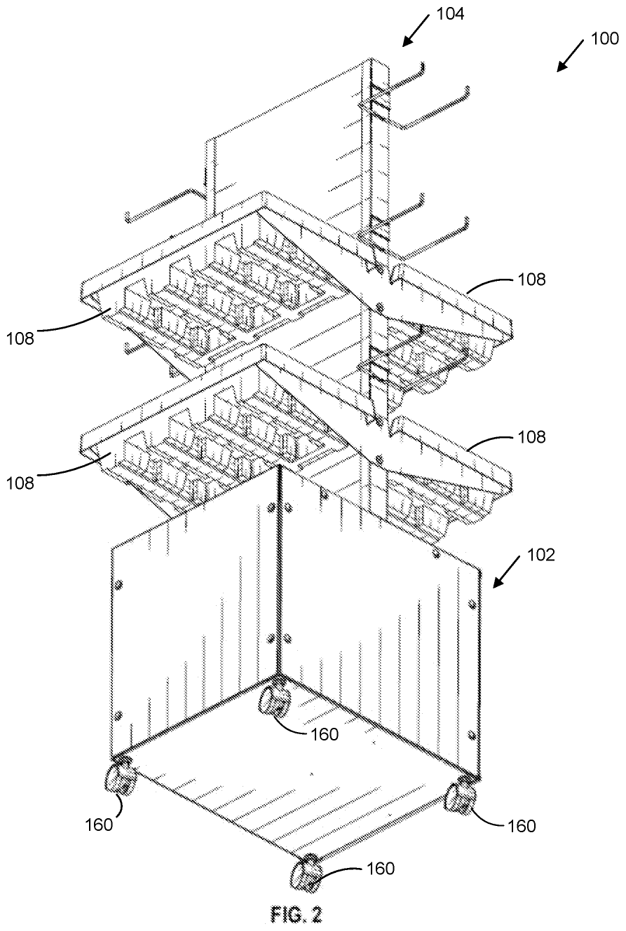

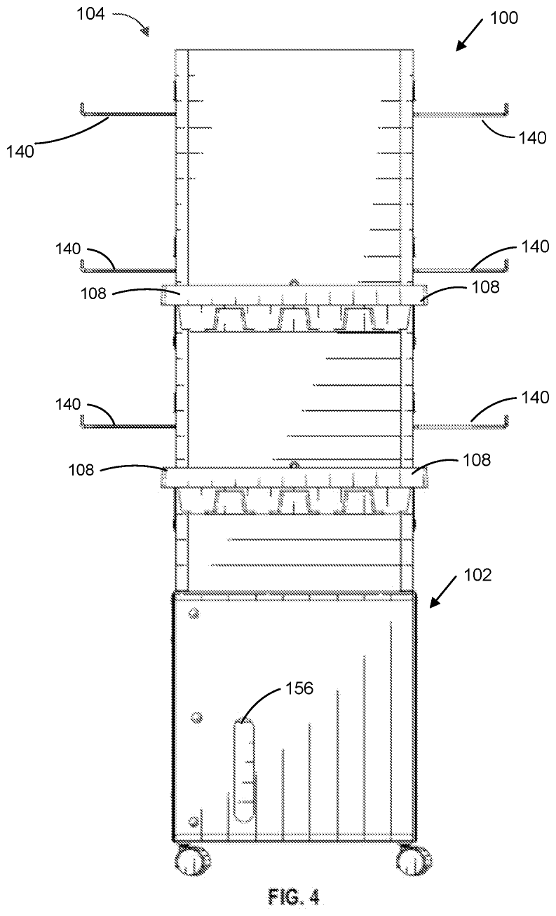

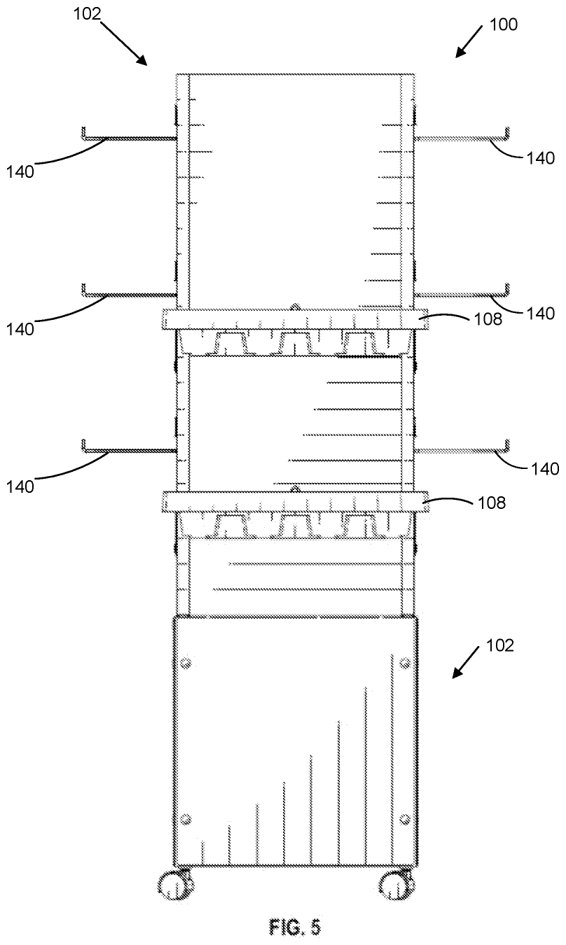

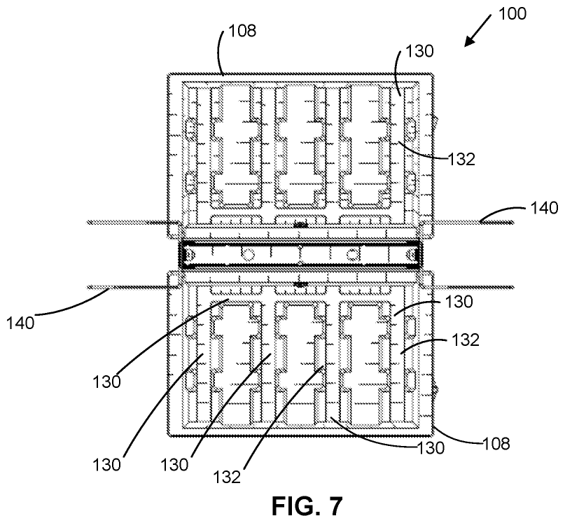

Described herein are novel devices, systems, and methods for displaying vegetation, wherein vegetation can be decorative plants, edible plants including herbs, flowers, or other plants. With reference to FIGS. 1-7, some embodiments of the apparatus 100 can be configured for displaying and automatically watering vegetation, and can have a base portion 102, a support member 104 coupled with the base portion 102, and one or more trays 108 supported by the support member 104. In some embodiments, the one or more trays 108 can be supported by or coupled with one or more brackets, such as, for example and without limitation, brackets 110. The brackets 110 can be supported by or coupled with the support member 104 using welds, screws, bolts, tabs and depressions, pins, or any suitable fasteners. In some embodiments, the support member 104 can include a single member. In other embodiments, the support member 104 can include multiple components that can be coupled together using welds, screws, bolts, or any suitable fasteners to form the support member 104. In any embodiments, the support member 104 can extend generally upwardly away from the base portion 104.

Additionally, any embodiments of the apparatus 100 can further include a container 114, at least one conduit 116 in fluid communication with the container 114 configured to communicate a liquid from the container 114 to the tray 108, and a pump 120 to pump liquid from the container through the conduit. In any embodiments, the conduit 116 can be positioned within the base portion 102 and/or the support member 104 so that the conduit is mostly concealed from view. With reference to FIG. 1, in some embodiments, the conduit 116 can extend through openings 118 in the support member 104. The openings 118 can be positioned above or adjacent to each of the trays 108 so that the conduit 116 can extend so as to be in communication with the one or more channels 130 in each tray 108. In other words, a distal end of the conduit 116 can be positioned over or within a space or volume within each of the trays 108 or the one or more channels 130. Additionally, in some embodiments, the support member 104 can have a frame or other structural supports therein. The frame or other structural supports can have openings or channels therein that the conduit 116 can pass through within the support member 104. In some embodiments, each of the trays 108 can have a tab or other connection element 119 that the conduit 116 can be coupled with. For example and without limitation, the connection element 119 can have a loop therein through which the conduit 116 can pass, or zip ties, wire ties, or other flaps, tabs, or other connectors can be used to removably or nonremovably couple the conduit 116 with the connection element 119 that can be coupled with or integrally formed with each tray 108.

The pump 120 can have electronic circuitry configured to control an operation of the pump. Further, the pump can be configured to pump a liquid from the container 114 through the conduit 116 to the tray 108 to water at least one plant that can be supported by the tray 108.

Some embodiments can include an apparatus for displaying and automatically watering vegetation, that can have a base portion 102, a frame coupled with the base portion 102, and one or more trays 108 supported by the frame. The apparatus can further have a refillable liquid container, at least one conduit 116 in fluid communication with the container 114 and configured to communicate a liquid from the container 114 to one or more plants supported by the one or more trays 108, and a pump 120 that can have electronic circuitry configured to control an operation of the pump 120. Each of the one or more trays 108 can have at least one channel to channel the liquid across the tray.

In any embodiments, during operation of the apparatus, the pump can be configured to automatically pump a liquid from the container 114 through the conduit 116 to the at least one channel of each of the one or more trays 108 at a predetermined frequency or when a liquid level within the at least one channel of at least one of the one or more trays 108 reaches a predetermined level. Additionally, any embodiments can have a timer that can be programmed to activate the pump at a desired time interval, or the pump can be actuated by a user by activating a push button, switch, dial, or other user input device.

### Container Details

The container 114 can be configured for holding and supporting a liquid therein, such as water, or water with other additives such as fertilizers and/or nutrients for the plants. In some embodiments, the container 114 can be positioned within an enclosure of the base portion. Additionally, the container 114 can be removable from the base portion 102 for refilling, exchanging, or otherwise. Further, in some embodiments, the pump 120 can be coupled with or integrated with the container, or can be a standalone pump device that can be positioned adjacent to, above, beside, or adjoined with the container. Additionally, in some embodiments, the container 114 can be configured such that a level of a liquid within the container 114 can be seen without opening the container 114 so that a user can quickly and easily determine whether or not the container 114 must be refilled, exchanged, or otherwise. Enabling quick and easy viewing of the liquid level within the container can also help determine the amount of liquid that is being consumed by the plants or otherwise used by the system to determine a necessary frequency of refilling the container. In any embodiments disclosed herein, the container can include a plurality of containers that can be configured to be in fluid communication with the conduit to provide a source of the liquid to the plants or other vegetation supported by the trays.

### Tray Details

In any embodiments, the tray 108 can have at least one channel 130 extending in at least a first direction across the tray 108 (such as across a width of the tray) to provide the liquid to one or more plants supported by the tray 108. In other embodiments, the tray 108 can have a plurality of channels 130 extending in the first direction and a second direction across the tray 108 to provide the liquid to one or more plants supported by the tray 108, the second direction being approximately perpendicular to the first direction. Additionally, in any embodiments, though not in all embodiments, the channel 130 can have a plurality of spaced apart depressions 132 having a width and/or depth that is different than a width and/or depth of the channels. In some embodiments, the channel 130 can have a plurality of spaced apart depressions 132 that are sized and configured to receive a potted plant or other vegetation. For example without limitation, the depressions 132 can be sized and configured to support an individual or even a set of plastic pots or starter pots of any desired size or shape. In some embodiments, the depressions can be sized and configured to approximately match a size and shape of an individual or a set of plastic pots or starter pots so that the pots can be positioned within the depressions and so that a bottom portion of the pots can be within the channels to receive a liquid communicated via the channels from the container.

In any embodiments disclosed herein, the apparatus can have one tray, two trays, or four trays, or more than four trays, or from 2 to 4 trays, or from 2 to 6 trays, or otherwise. Additionally, in any embodiments, the apparatus can have one or more racks 140 supported by the support member, wherein each of the one or more racks 140 can be configured to support a plant, a hanging plant, a pot, or other items associated with the plants that are on display on the apparatus. For example, the apparatus can have four or six racks 140, six being shown.

Any of the trays 108 can be removably or non-removably supported by at least one bracket 110. In some embodiments, the tray 108 can be configured to be removable from the at least one bracket 110 without the use of tools. For example and without limitation, one or more of the trays 108 can be removable from the bracket 110 by only moving the tray 108 away from the bracket 110. In other words, the tray 108 can be removed from the bracket 110 simply by lifting the tray 108 away from the bracket 110.

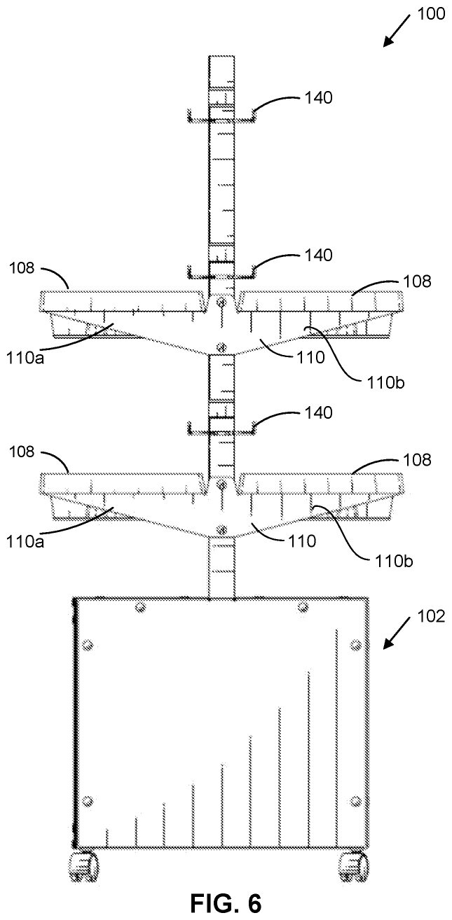

Any embodiments of the apparatus can have a plurality of brackets 110 and a plurality of trays 108. Additionally, with reference to FIG. 6, any of the brackets 110 can have a first bracket portion 110a and a second bracket portion 110b, wherein the first bracket portion 110a extends in a first direction and supports a first tray 108, and the second bracket portion 110b extends in a second direction and supports a second tray 108. The second direction can be opposite to the first direction such that the first direction and the second direction are mutually opposing, as shown in FIG. 6. Any of the brackets 110 of the apparatus 100 can have a first bracket portion 110a extending in a first direction and a second bracket portion 110b extending in a second direction, wherein each of the first and second bracket portions 110a, 110b, can support at least one tray 108. In any embodiments, the brackets 110 can be configured to support one tray, two trays, four trays, or more.

### Base Portion

In any embodiments, the base portion 102 can include a cabinet 150, such as, without limitation a cabinet made out of wood, aluminum, plastic, or otherwise. The cabinet 150 can be in openable enclosure for housing the container, the pump, and/or other items. For example, in some embodiments, the base portion 102 can have a cabinet 150 having a door 152. The door can have hinges or can be slidable along a track 154 supported by the cabinet 150. In some embodiments, the door or other component of the base portion 102 can be configured to permit a user to view a level of the liquid within the container without opening the enclosure or the container. For example, in some embodiments, the cabinet 150 can have a viewing window 156 in a portion of the cabinet 150, such as in a door 152 of the cabinet, wherein the viewing window can be aligned with the container 114 to permit a viewing of a level of a liquid within the container 114.

Additionally, in any embodiments, the base portion 102 can have a plurality of wheels 160 configured to support the apparatus and permit the apparatus to be rolled or otherwise moved easily across the floor. The wheels 160 can have brakes or other locking mechanisms to prevent the rolling of the wheels 160.

### Pump and Electronics

In any embodiments, the pump 120 can have electronic circuitry that can have a processor 170 and a machine-readable memory component or components 172. The machine-readable memory can store executable instructions. The electronic circuitry can be configured to activate the pump to provide a predetermined amount of the liquid from the container 114 to the one or more trays 108. For example and without limitation, the electronic circuitry can be configured to activate the pump to provide a predetermined amount of the liquid from the container 114 to the one or more trays 108 at a predetermined frequency (such as could be programmed with a timer) and/or upon the occurrence of a predetermined event when the apparatus is in an operable state. The predetermined event can include a level of the liquid in the tray reaching a predetermined value or level, for example an approximately zero value, or when the tray is only 5% full, or only 10% full. In other words, the predetermined event can occur when the tray becomes substantially dry, or when there is only a limited amount of the liquid in the tray. In other embodiments, the predetermined event can occur when a moisture level within one or more plants supported by the tray reaches a predetermined level (which can be determined by one or more sensors 190).

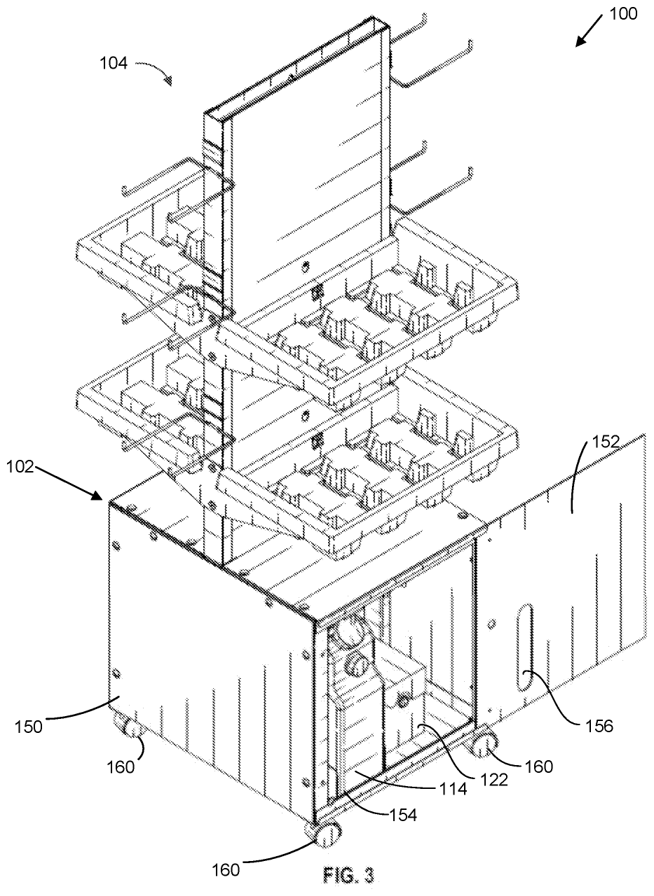

Any embodiments of the apparatus can have a source of power in communication with at least the pump. The source of power can include one or more batteries (such as battery 122 shown in FIG. 3), an AC power source, a DC power source, one or more solar panels, and/or any other suitable power source. In any embodiments, the apparatus can further have a wireless communications device 174 electronically coupled with the electronic circuitry and configured to communicate data and/or information regarding the apparatus or the vegetation or plant supported by the apparatus to another user, a mobile device, and/or a server, or to receive instructions from an external source, such as another computer, personal electronic device, or otherwise to control one or more parameters of the operation of the apparatus. For example and without limitation, a user can remotely turn on or off the pump, can adjust the frequency and or the volume of liquid dispensed by the pump, and/or other operating parameters associated with the apparatus. Any embodiments of the apparatus can also have one or more grow lamps or grow lights that can be positioned above the one or more trays 108 and that can be controlled by the electronic circuitry and/or controlled remotely or wirelessly.

### Sensors

In any embodiments, the apparatus can have one or more sensors 190 configured to determine a level of a liquid within the tray, an amount of light received by the plants supported by the trays, or otherwise. The apparatus can have at least one sensor 190 for each tray of the apparatus.

While certain arrangements of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a sub combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An apparatus for displaying and automatically watering vegetation, comprising:
a base portion;
a support member coupled with the base portion and extending generally upwardly away from the base portion;
a bracket;
a tray supported by the bracket;
a container;
at least one conduit in fluid communication with the container and configured to communicate a liquid from the container to the tray; and
a pump comprising electronic circuitry configured to control an operation of the pump;
wherein:
the pump is configured to pump a liquid from the container through the conduit to the tray to water at least one plant that can be supported by the tray.

2. The apparatus of claim 1, wherein the container is removably positioned within an enclosure of the base portion.

3. The apparatus of claim 1, comprising a plurality of conduits in fluid communication with the container and configured to communicate a liquid from the container to a plurality of trays, wherein the plurality of conduits extend from the base portion through a space within the support member so that at least an entire portion of the plurality of conduits within the support member are concealed from view.

4. The apparatus of claim 1, wherein the tray comprises at least one channel extending in at least a first direction across the tray to provide the liquid to one or more plants supported by the tray, and wherein the apparatus is configured to direct the liquid from the at least one conduit to the at least one channel.

5. The apparatus of claim 4, wherein the tray comprises a plurality of channels extending in a first direction and a second direction across the tray to provide the liquid to one or more plants supported by the tray, wherein the second direction is approximately perpendicular to the first direction.

6. The apparatus of claim 4, wherein the channel comprises a plurality of spaced apart depressions, wherein each of the depressions is sized and configured to receive a potted plant.

7. The apparatus of claim 1, wherein the tray is removably supported by at least one bracket, the tray being removable from the at least one bracket without the use of tools by lifting the tray away from the at least one bracket.

8. The apparatus of claim 1, further comprising a four or more brackets and four or more trays, wherein each of the four or more trays is supported by one of the four or more brackets.

9. The apparatus of claim 1, wherein the bracket comprises a first bracket portion extending in a first direction and a second bracket portion extending in a second direction, the second direction being opposite to the first direction, and wherein the apparatus comprises a tray supported on each of the first bracket portion and the second bracket portion.

10. The apparatus of claim 1, wherein the base portion comprises a cabinet and a plurality of wheels configured to support the apparatus and permit the apparatus to be rolled.

11. The apparatus of claim 1, comprising a viewing window in a portion of the base portion, wherein the viewing window is aligned with the container to permit a viewing of a level of a liquid within the container through the viewing window.

12. The apparatus of claim 1, wherein the electronic circuitry of the pump comprises a machine-readable memory storing executable instructions, the electronic circuitry being configured to activate the pump to provide a predetermined amount of the liquid from the container to the tray at a predetermined frequency and/or upon the occurrence of a predetermined event when the apparatus is in an operable state.

13. The apparatus of claim 12, wherein the predetermined event comprises a level of the liquid in the tray reaching a predetermined value.

14. The apparatus of claim 12, wherein the predetermined event comprises a level of the liquid in the tray reaching an approximately zero value.

15. The apparatus of claim 12, wherein the predetermined event occurs when the tray becomes substantially dry.

16. The apparatus of claim 12, wherein the predetermined event occurs when a moisture level within one or more plants supported by the tray reaches a predetermined level.

17. The apparatus of claim 1, further comprising a wireless communications device electronically coupled with the electronic circuitry.

18. The apparatus of claim 1, comprising one or more sensors configured to determine a level of a liquid within the tray.

19. The apparatus of claim 1, comprising at least one sensor for each tray of the apparatus.

20. An apparatus for displaying and automatically watering vegetation, comprising:
a base portion;
a frame coupled with the base portion;
one or more trays supported by the frame, each of the one or more trays comprising at least one channel;
a refillable liquid container;
at least one conduit in fluid communication with the container and configured to communicate a liquid from the container to one or more plants supported by the one or more trays; and
a pump comprising electronic circuitry configured to control an operation of the pump;
wherein:
during operation of the apparatus, the pump is configured to automatically pump a liquid from the container through the conduit to the at least one channel of each of the one or more trays at a predetermined frequency or when a liquid level within the at least one channel of at least one of the one or more trays reaches a predetermined level.
